(19) United States
(12) Patent Application Publication
(10) Pub. No.: US 2008/0277197 A1
(43) Pub. Date: Nov. 13, 2008

(54) DIAPHRAGM STRUCTURE FOR MICRO-ELECTROACOUSTIC DEVICE

(75) Inventors: TSUNG-LUNG YANG, Tu-Cheng (TW); HSIEN-SHENG PEI, Tu-Cheng (TW); SHENG-KAI HSU, Tu-Cheng (TW); KUEN-YING OU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/772,809

(22) Filed: Jul. 2, 2007

(30) Foreign Application Priority Data
May 9, 2007 (CN) 200710074327.3

(51) Int. Cl. G10K 13/00; H04R 31/00; H04R 7/16

(52) U.S. Cl. 181/171; 29/896.23

(57) ABSTRACT

A diaphragm structure (10) includes an oscillating diaphragm (11) and a strengthening member (13) superposed on and surrounding a periphery of the oscillating diaphragm. The strengthening member is hot-pressed on the periphery of the oscillating diaphragm. The strengthening member has a higher melting temperature than that of the oscillating diaphragm, and the strengthening member and the oscillating diaphragm are cooled after they are heat-pressed in a mold to thereby obtain residual stress in the oscillating diaphragm.

### BACKGROUND OF THE INVENTION

1. Field of the Invention

The present invention relates generally to micro-electroacoustic devices, and more particularly to a diaphragm structure for a micro-electroacoustic device.

2. Description of Related Art

Sound is one important means by which people communicate with each other, thus creating new methods for sound transference which allows greater communication between people. Electroacoustic transducers are key components in transferring sound. A typical electroacoustic transducer has a magnetic circuit in which a magnetic field generated by a magnet passes through a base member, a magnetic core and a diaphragm structure and returns to the magnet again. When an oscillating electric current is supplied to a coil wound around the magnetic core, the corresponding oscillating magnetic field generated by the coil is then superimposed onto the magnetostatic field of the magnetic circuit. The resulting oscillation generated in the diaphragm structure is then transmitted to the air as sound. The basic loudspeaker, in which electric energy is converted to acoustic energy, is a typical electroacoustic transducer. There are many different types of loudspeakers, including electrostatic loudspeakers, piezoelectric loudspeakers, and moving-coil loudspeakers.

Nowadays, mobile phones are widely used and loudspeakers are important components packaged within mobile phones. As design style for mobile phones emphasizes lightness, thinness, shortness, smallness, energy-efficiency, low cost, the space available for loudspeakers within mobile phones is therefore limited. Furthermore, as more and more mobile phones are being used to play MP3s, the rated power of the loudspeakers needs to increase. The space occupied by a loudspeaker mainly depends on the maximum deformation displacement of an oscillating diaphragm of the loudspeaker.

Therefore, it is desired to design a new diaphragm structure for micro-electroacoustic transducers which may undergo an increased power to generate louder sound while occupying a smaller amount of space.

### SUMMARY OF THE INVENTION

The present invention relates, in one aspect, to a diaphragm structure for a micro-electroacoustic device. The diaphragm structure includes an oscillating diaphragm, and a strengthening member superposed on and surrounding a periphery of the oscillating diaphragm. The oscillating diaphragm includes an oscillating part and a joint part surrounding and integrally formed with the oscillating part. The strengthening member is pressed on the joint part of the oscillating diaphragm so as to increase rigidity of the diaphragm structure.

The present invention relates, in another aspect, to a method for manufacturing the diaphragm structure. The method includes the steps of: providing a piece of polymeric membrane and the strengthening member; putting the polymeric membrane and the strengthening member into a hot-press mold; heating the polymeric membrane and the strengthening member to a temperature which is higher than a softening temperature of the polymeric membrane but lower than a softening temperature of the strengthening member; heat pressing an indent in the polymeric membrane so as to form the oscillating part and the joint part of the oscillating diaphragm and heat pressing the strengthening member onto the oscillating diaphragm so as to obtain a rough diaphragm structure; cooling the rough diaphragm structure while it is in the mold so that a residual stress is obtained in the rough diaphragm; separating the mold and pushing the rough diaphragm structure out of the mold; obtaining the diaphragm structure.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a partly cut-away isometric view of a diaphragm structure in accordance with a preferred embodiment of the present invention;

FIG. 2 is a partly cut-away isometric view of an oscillating diaphragm of the diaphragm structure of FIG. 1 (i.e., a diaphragm structure without a strengthening member of FIG. 1);

FIG. 3 is a front view of the diaphragm structure in accordance with the preferred embodiment of the present invention; and

FIG. 4 is an isometric view of a strengthening member of the diaphragm structure of FIG. 1.

### DETAILED DESCRIPTION OF THE INVENTION

Reference will now be made to the drawing figures to describe the preferred embodiment in detail.

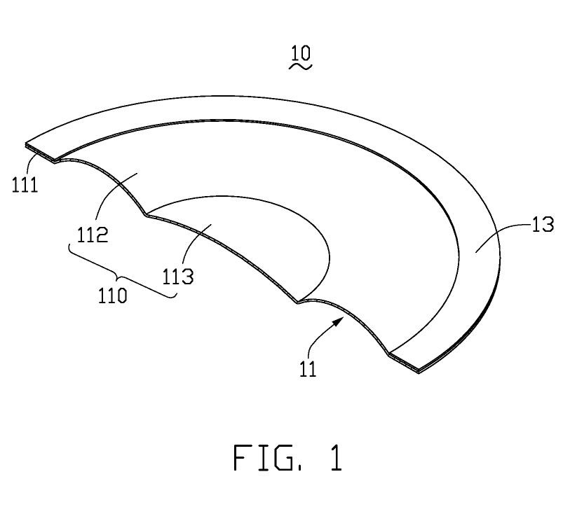

FIG. 1 is a partly cut-away isometric view of a diaphragm structure 10 in accordance with a preferred embodiment of the present invention. The diaphragm structure 10 is used for micro-electroacoustic transducers, such as receivers, loudspeakers of mobile phones or notebooks. In the preferred embodiment, the diaphragm structure 10 is round in shape as viewed from above. The diaphragm structure 10 includes an oscillating diaphragm 11 and an annular strengthening member 13 superposed on and surrounding a periphery of the oscillating diaphragm 11.

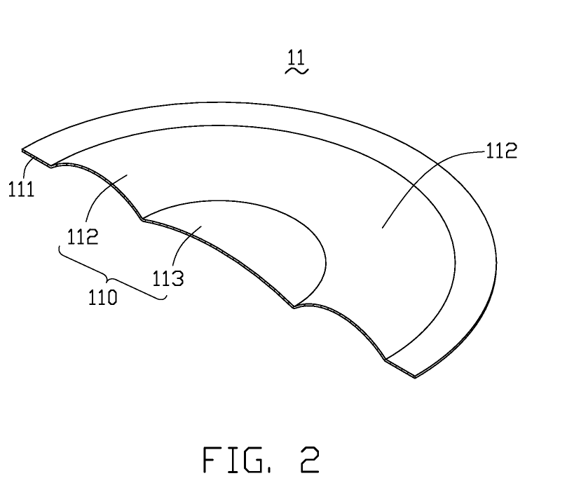

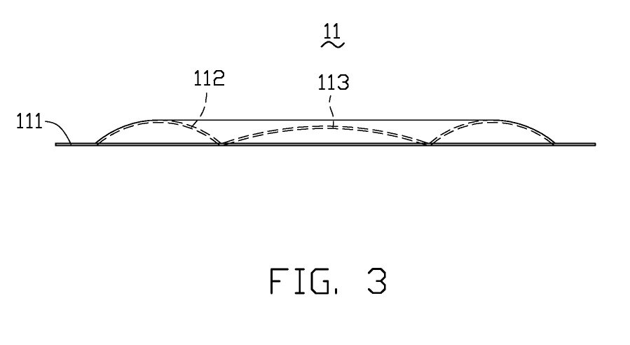

Referring to FIG. 2, the oscillating diaphragm 11 is made of polymeric materials, such as PEI (Polyetherimide), PI (Polyimide), PP (Polypropylene), PEN (Polyethylene naphthalate) or PET (Polyethylene glycol terephthalate). The oscillating diaphragm 11 is round in shape as viewed from above and has a thickness from 5 to 50 μm. The oscillating diaphragm 11 includes a plate-like oscillating part 110 and a joint part 111 concentric and integrally formed with the oscillating part 110. The oscillating part 110 includes a central portion 113 and a peripheral portion 112 integrally formed with and surrounding a periphery of the central portion 113. Particularly referring to FIG. 3, the periphery of the central portion 113 of the oscillating part 110 is coplanar with a bottom surface of the joint part 111. The central portion 113 of the oscillating part 110 has an arc-shaped cross section. A vertical distance between the central portion 113 of the oscillating part 110 and the joint part 111 gradually increases from the periphery of the central portion 113 towards a center thereof. The peripheral portion 112 is ring shaped as viewed from above and has an arc shaped cross section. A vertical distance between the peripheral portion 112 of the oscillating part 110 and the joint part 111 gradually increases from inner and outer edges of the peripheral potion 112 towards a centre thereof. A topmost point of the central portion 113 of the oscillating part 110 is lower than a topmost point of the peripheral portion 112 of oscillating part 110.

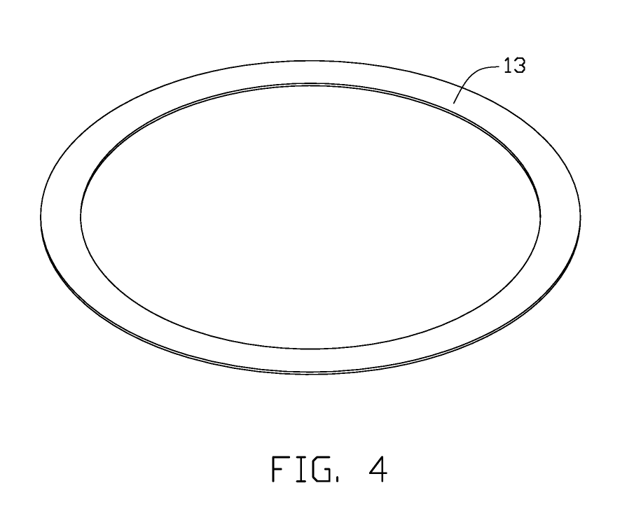

Referring to FIG. 4, the strengthening member 13 of the diaphragm structure 10 is made of materials having higher rigidity and melting point than those of the oscillating diaphragm 11. In this embodiment, the strengthening member 13 is made of metal such as copper. The strengthening member 13 is ring shaped in profile and concentric with the oscillating part 110 of the oscillating diaphragm 11. A thickness of the strengthening member 13 is from 5 to 30 μm, whilst a width of the strengthening member 13 is from 1 to 10 mm. The strengthening member 13 is heat-pressed on the joint part 111 of the oscillating diaphragm 11 thereby to be securely fastened to the joint part 111. An outer diameter of the strengthening member 13 equals to an outer diameter of the joint part 111 of the oscillating diaphragm 11. A width of the strengthening member 13 is less than or equal to a width of the joint part 111 of the oscillating diaphragm 11. The strengthening member 13 increases the rigidity of the diaphragm structure 10. That is, compared with a conventional diaphragm structure without the strengthening member 13, the maximum deformation displacement of the diaphragm structure 10 of the preferred embodiment of the present invention is less when undergoing the same power. Thus, a loudspeaker fitted with the diaphragm structure 10 of the preferred embodiment occupies smaller space than a loudspeaker using the conventional diaphragm structure. Understandably, a loudspeaker fitted with the diaphragm structure 10 of the preferred embodiment and occupying the same space as the loudspeakers fitted with conventional the diaphragm structures can undergo larger amounts of power. This is due to the rigidity of the diaphragm structure 10 of the preferred embodiment being larger than that of the conventional diaphragm structure.

Table 1 shows the maximum deformation displacements of different diaphragm structures, i.e., diaphragm structures of FIGS. 1 and 2, when the diaphragm structures are driven by the same power. The diaphragm structure of FIG. 2 is substantially the same as the diaphragm structure 10 of FIG. 1 except that the diaphragm structure of FIG. 2 has no strengthening member 13 joined to the oscillating diaphragm 11. When the power pushes the oscillating diaphragms to move upwardly, tensile stresses are generated. When the power pushes the oscillating diaphragms to move downwardly, compressive stresses are generated. The tensile stress means that the oscillating diaphragms of the diaphragm structures deform upwardly, and the compressive stress means that the oscillating diaphragms of the diaphragm structures deform downwardly.

TABLE 1

| | | | Maximum deformation |
|---|---|---|---|
| | | Stress due to force | displacement of the |
| | Diaphragm | exerted on the | diaphragm structure |
| Serial No. | structures | diaphragm structures | (mm) |
| 1 | Diaphragm | Compressive stress | 2.965 |
| 2 | structure of | Tensile stress | 2.965 |
| | FIG. 1 | | |
| 3 | Diaphragm | Compressive stress | 3.688 |
| 4 | structure of | Tensile stress | 3.688 |
| | FIG. 2 | | |

From table 1, one can conclude that if the diaphragm structures undergo the same power, the maximum deformation displacement of the diaphragm structure 10 of FIG. 1 is smaller than that of the diaphragm structure of FIG. 2. This means that the strengthening member 13 joined to the oscillating diaphragm 11 can increase the rigidity of the diaphragm structure 10.

In addition, the present invention also provides a method for manufacturing the diaphragm structure 10. The method includes the steps of: providing a piece of polymeric membrane and the strengthening member 13; putting the polymeric membrane and the strengthening member 13 into a hot-press mold; heating the polymeric membrane and the strengthening member 13 to a temperature which is higher than a softening temperature of the polymeric membrane but lower than a softening temperature of the strengthening member 13; pressing a plate-like indent in the polymeric membrane so as to form the oscillating part 110 and the joint part 111 of the oscillating diaphragm 11; pressing the oscillating diaphragm 11 to the strengthening member 13 so as to obtain a rough diaphragm structure 10; cooling the rough diaphragm structure 10 to a temperature which is 10 to 100° C. lower than the softening temperature of the oscillating diaphragm 11 or cooling the rough diaphragm structure 10 to room temperature whereby a residual stress is existed in the rough diaphragm structure 10; separating the mold and taking the rough diaphragm structure 10 out of the mold; obtaining the diaphragm structure 10.

During manufacturing of the diaphragm structure 10, when the oscillating diaphragm 11 and the strengthening member 13 are heated, the oscillating diaphragm 11 is expanded. The strengthening member 13 which is firmly compressed in the mold blocks the oscillating diaphragm 11 to expand outwardly. Therefore, there is residual compressive stress remained in the oscillating diaphragm 11 of the diaphragm structure 10. When the oscillating diaphragm 11 and the strengthening member 13 are cooled, the oscillating diaphragm 11 shrinks. The strengthening member 13 upholds the oscillating diaphragm 11 to prohibit it from shrinking inwardly. Therefore, there is residual tensile stress remained in the oscillating diaphragm 11 of the diaphragm structure 10. Whether there is tensile stress or compress stress left in the oscillating diaphragm 11 is decided by the duration, speed and temperature of the heating and cooling process. For the conventional diaphragm structure, there is no such residual stress or only a very small amount left therein, since once the conventional diaphragm structure is formed, the mold is opened and the conventional diaphragm is taken out from the mold and cooled in a free condition. Inventor has found that the residual stress existed in the oscillating diaphragm 11 can greatly increase the rigidity of the oscillating diaphragm 11 thereby to help improving the acoustic characteristics of the diaphragm structure 10. More explanations regarding this are given below.

In order to understand the effect of the residual stress for the diaphragm structure 10, applicant has tested the maximum deformation displacements of different diaphragm structures, i.e., diaphragm structures of FIGS. 1 and 2, supposing that the diaphragm structures have the same dimensions and are made of the same material, except that the diaphragm structure 10 of FIG. 1 has the heat-bonded strengthening member 13. Moreover, the powers applied to the diaphragm structures are also equal to each other. Table 2 shows the results of the test.

TABLE 2

| | | | | Maximum |
|---|---|---|---|---|
| | | | Stress due to force | deformation |
| | | | exerted on the | displacement of the |
| Serial | | Diaphragm | diaphragms | diaphragm structure |
| No. | Residual stress | structures | structures | (mm) |
| 5 | Compressive | Diaphragm | Tensile stress | 2.767 |
| | stress | structure of FIG. 1 | | |
| 6 | Tensile stress | | Tensile stress | 3.162 |
| 7 | Compressive | | Compressive | 3.162 |
| | stress | | stress | |
| 8 | Tensile stress | | Compressive | 2.767 |
| | | | stress | |
| 9 | | Diaphragm | Tensile stress | 3.354 |
| 10 | | structure of FIG. 2 | Tensile stress | 4.024 |
| 11 | | | Compressive | 4.024 |
| | | | stress | |
| 12 | | | Compressive | 3.354 |
| | | | stress | |

From table 2, one can conclude that when the diaphragm structures of FIGS. 1 and 2 undergo the same power, the maximum deformation displacements of the diaphragm structure 10 of FIG. 1 are smaller than the maximum deformation displacements of the diaphragm structure of FIG. 2. This means that the sound wave generated by the diaphragm structure of FIG. 1 has a small amount of Total Harmonic Distortion. Thus, the diaphragm structure 10 can generate a sound with better quality.

In other words, from table 2, one can conclude that when the diaphragm structures of FIGS. 1 and 2 undergo the same power, the maximum deformation displacement of the diaphragm structure 10 of FIG. 1 is smaller than that of the diaphragm structure of FIG. 2. Thus, the strengthening member 13 joined to the oscillating diaphragm 11 can increase the rigidity of the diaphragm structure 10. A loudspeaker fitted with the diaphragm structure 10 of the preferred embodiment and occupying the same space as the loudspeakers fitted with the conventional diaphragm structure can undergo a larger power to drive it; thus, the loudspeaker fitted with the diaphragm structure 10 can have a higher power rate to output a larger volume.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A diaphragm structure comprising:
an oscillating diaphragm; and
a strengthening member superposed on and surrounding a periphery of the oscillating diaphragm, the oscillating diaphragm and the strengthening member being made of different materials, the oscillating diaphragm having a residual stress therein.

2. The diaphragm structure as described in claim 1, wherein the oscillating diaphragm comprises a joint part, the strengthening member being heat-pressed to the joint part to thereby be securely fastened to the joint part.

3. The diaphragm structure as described in claim 2, wherein the oscillating diaphragm further comprises an oscillating part, the joint part being integrally formed with and surrounding a periphery of the oscillating part.

4. The diaphragm structure as described in claim 3, wherein the oscillating part comprises a central portion and a peripheral portion integrally formed at a periphery of the central portion, a vertical distance between the central portion of the oscillating part and the joint part gradually increasing from the periphery of the central portion towards a center thereof, and a vertical distance between the peripheral portion of the oscillating part and the joint part gradually increasing from inner and outer edges of the peripheral potion towards a centre of the peripheral portion.

5. The diaphragm structure as described in claim 4, wherein the periphery of the central portion of the oscillating part is coplanar with the joint part.

6. The diaphragm structure as described in claim 4, wherein a topmost point of the central portion of the oscillating part is lower than that of the periphery portion of oscillating part.

7. The diaphragm structure as described in claim 1, wherein the material for forming the strengthening member has rigidity and melting point higher than those of the material for forming the oscillating diaphragm.

8. The diaphragm structure as described in claim 7, wherein the material for forming the strengthening member is metal.

9. The diaphragm structure as described in claim 1, wherein an outer diameter of the strengthening member equals to an outer diameter of the oscillating diaphragm.

10. A method for manufacturing a diaphragm structure, the diaphragm structure comprising an oscillating diaphragm having an oscillating part and a joint part surrounding the oscillating part, and an annular strengthening member joined to the joint part of the oscillating diaphragm, comprising:
providing a piece of polymeric membrane and the strengthening member;
putting the polymeric membrane and the strengthening member into a hot-press mold;
heating the polymeric membrane and the strengthening member to a temperature which is higher than a softening temperature of the polymeric membrane but lower than a softening temperature of the strengthening member;
heat pressing an indent in the polymeric membrane so as to from the oscillating part and the joint part of the oscillating diaphragm, and heat pressing the strengthening member onto the joint part of the oscillating diaphragm so as to obtain a rough diaphragm structure;
cooling the rough diaphragm structure while the rough diaphragm remains in the mold whereby a residual stress is obtained in the oscillating diaphragm;
separating the mold and taking the rough diaphragm structure out of the mold to obtain the diaphragm structure.

11. The method as described in claim 10, wherein the step of cooling the rough diaphragm structure comprises cooling the rough diaphragm structure to a temperature which is 10 to 100° C. lower than the softening temperature of the oscillating diaphragm.

12. The method as described in claim 10, wherein the indent is plate-like in shape, and comprises a central portion and a periphery portion surrounding a periphery of the central portion, a vertical distance between the central portion of the oscillating part and a bottom surface of the joint part gradually increasing from the periphery of the central portion towards a center thereof, and a vertical distance between the peripheral portion of the oscillating part and the joint part gradually increasing from inner and outer edges of the peripheral potion towards a centre thereof.

13. The method as described in claim 10, wherein the strengthening member is made of metal.

14. The method as described in claim 13, wherein the strengthening member is made of copper.
